(19) United States
(12) Patent Application Publication
(10) Pub. No.: US 2026/0316388 A1
(43) Pub. Date: Oct. 15, 2026

(54) FLUID SYSTEM AND METHOD FOR SUPPLYING A FLUID TO A PRINTHEAD IN A 3D PRINTER

(71) Applicant: Laempe Moessner Sinto GmbH, Barleben (DE)

(72) Inventors: Frank WEDEMEYER, Zell im Wiesental (DE); Rudolf WINTGENS, Schopfheim, Wiechs (DE); Ivan GEAR, Bad Säckingen (DE)

(21) Appl. No.: 19/475,544

(22) PCT Filed: Apr. 8, 2024
(86) PCT No.: PCT/DE2024/000025

§ 371 Date: Oct. 15, 2025

(30) Foreign Application Priority Data
Apr. 21, 2023 (DE) 10 2023 001 578.4

(51) Int. Cl. B29C 64/321; B29C 64/209; B29C 64/343; B33Y 30/00; B33Y 40/00

(52) U.S. Cl. CPC B29C 64/321; B29C 64/209; B29C 64/343; B33Y 30/00; B33Y 40/00

(57) ABSTRACT

The invention, which relates to a fluid system (12) and a method for supplying a fluid (7) to a printhead (1) in a 3D printer, is based on the object of providing a solution by which a reliable supply of the fluid (7) to several metering units (2) in one or more printheads (1) is ensured, wherein fluctuations in the fluid pressure are reduced and a print image is improved during the layer-by-layer generation of a 3D structure. This object is achieved in terms of the arrangement in that a distribution block (17) is arranged between the storage tank (16) and the printhead tank (14), wherein the distribution block (17) has an inlet (18) which is connected to the storage tank (16) via a fluid feed line (19), and an outlet (20) which is connected to the storage tank (16) via a fluid return line (21), wherein the distribution block (17) has at least two further connections (22), which are each connected to a printhead tank (14) via a fluid line (15), and wherein a pump (23) is arranged in the fluid feed line (19) and a control valve (34) is arranged in the fluid return line (21).

The invention relates to a fluid system for supplying a fluid to a printhead in a 3D printer, wherein the printhead has a plurality of metering units and is connected to a printhead tank, and wherein the printhead tank is connected at least indirectly via a fluid line to a storage tank for storing the fluid.

The invention also relates to a method for conveying a fluid to a printhead in a 3D printer, wherein a fluid is conveyed from a storage tank at least indirectly into a printhead tank of the printhead, wherein the provided printhead tank is connected to a printhead for supplying the fluid to the printhead.

In particular, the invention relates to a fluid system and a method for supplying a fluid to a printhead in a 3D printer, wherein a fluid such as a binder is applied to a layer of a particulate building material produced on a construction field of the 3D printer through nozzles of the metering units arranged in a printhead in order to achieve selective solidification during the production of a 3D structure in the 3D printer.

It is known to use 3D printing or a 3D printing process to produce individual or series-produced components, workpieces, or molds. In such printing processes, three-dimensional components or workpieces are manufactured layer by layer.

The structure is computer-controlled and constructed from one or more liquid or solid materials according to specified dimensions and shapes. Specifications for the components or workpieces to be printed can be provided, for example, by computer-aided design (CAD) systems.

When printing 3D structures or 3D components, physical or chemical hardening processes or a melting process take place in a particulate building material, which is also known as a molding material. Materials used for such 3D printing processes include building materials or molding materials such as plastics, synthetic resins, ceramics, unsolidified sediments such as minerals or sands, and metals.

Various manufacturing processes are known when implementing 3D printing processes.

However, several of these processes include the following exemplary process steps:
Partial or full-surface application of particulate building material, also referred to as particulate material or powdered building material, to a so-called construction field in order to form a layer of unsolidified particulate material, wherein the partial or full-surface application of particulate building material includes spreading and smoothing the particulate building material;
Selectively solidifying the applied layer of unsolidified particulate building material in predetermined partial areas, for example by selectively compacting, printing or applying treatment agents, such as a fluid or binder, by means of a printhead, by using a laser or electron beams;
Repetition of the previous process steps in another layer level for the layer-by-layer buildup of the component or workpiece. For this purpose, the component or workpiece, which is being produced or printed layer-by-layer on the construction field, is lowered together with the construction field by one layer level or layer thickness, or the 3D printing device is raised by one layer level or layer thickness relative to the construction field before a new layer is applied partially or completely.
Subsequent removal of loose, unsolidified particulate construction material surrounding the manufactured component or workpiece.

A particulate building material is generally understood to be a collection of individual particles of a substance or mixture of substances, each of which has a three-dimensional extent. Since these particles can predominantly be considered round, oval, or elongated, it is possible to specify an average diameter for such a particle, which usually ranges between 0.01 mm and 0.4 mm. Such a particulate building material can exhibit fluid properties.

Various methods for creating a 3D structure or for dispensing and applying particulate building material to a construction field to create a 3D structure are known from the prior art. Likewise, various fluid systems and methods for supplying a fluid to a printhead in a 3D printer are known.

It is known to print or apply treatment agents, such as a fluid or binding agent, using for example a printhead, in which several so-called metering units with corresponding nozzles are arranged. In one example, the metering units and their nozzles are arranged in a matrix with several rows and several columns in the printhead. Each metering unit in the printhead can be controlled separately, with the metering unit dispensing a predetermined amount (drops) of the fluid or binding agent via its nozzle onto the particulate material of the layer currently being produced, which has already been applied to the construction field.

EP 3 177 453 B1 discloses a printhead, its use, and a 3D printing method. The problem to be solved is to provide a printhead that avoids the stated disadvantages of the prior art.

The solution proposes a printhead that is particularly suitable for the selective application of printing fluid to a particulate material when producing three-dimensional models using a layered build-up process. A printhead tank for holding the printing fluid is connected to printhead modules through which the printing fluid is directed into pump chambers and to the nozzles of a printhead. The printhead tank is filled by connecting it via tubing to an intermediate tank, which can be connected to one of several reservoirs for the printing fluid via a valve block.

Furthermore, a metallic carrier is provided to which the printhead modules are attached. Furthermore, plastic fluid guides extending through the metallic carrier are provided to guide the printing fluid. Thus, metallic parts for positioning are eliminated so that plastic parts that do not directly influence the positioning of the printhead can be used for fluid guidance.

EP 3 600 843 B1 discloses a method for producing a three-dimensional object by additive manufacturing from a mixed resin. The objective is to create an additive manufacturing method that enables the production of objects with diverse or finely tuned mechanical properties.

To achieve this object, a method for producing a three-dimensional object by additive manufacturing from a mixed resin is provided, wherein the mixed resin comprises at least one light-polymerizable first component and optionally, but preferably, at least one or more second solidifiable components which are different from the first component.

In this method, after providing a first resin and a second resin, the first and second resins are mixed together to produce the mixed resin from which a three-dimensional object with mechanical properties can be produced.

After selectively dispensing the mixed resin to the construction field of an additive manufacturing device, a three-dimensional object is produced from the mixed resin in the device for producing the three-dimensional object. The various resins are stored in separate tanks, fed to a mixing device via valves and pumps, and dispensed via appropriate nozzles.

A general problem with the known prior art is that the fluid systems for supplying a fluid to a printhead and its nozzles have regions, such as lines, in which the fluid to be supplied to the printhead has at least temporarily zero flow velocity or is stationary in a tank or line. Such a situation occurs, for example, when the printhead or intermediate tanks do not participate in supplying or refilling the fluid. When a tank or intermediate tank in the system for supplying a fluid has a sufficiently high fill level, it will most likely no longer be necessary to further fill or refill this tank or intermediate tank for a certain period of time. The fluid is only supplied again when a corresponding sensor in this tank or intermediate tank detects a dropped fill level.

Fluid standing in tanks, in intermediate tanks, and especially in pipes can form so-called flocculates or agglomerates. This occurs with both organic and inorganic fluids or binders used to bind the particulate building material. The formation of such flocculates or agglomerates can result in blockages and/or pressure fluctuations in the fluid system and/or increased viscosity of the binder. A blockage of a pipe, valve, or nozzle can also cause inaccuracies or errors when creating a 3D structure in the 3D printer, for example, because too little fluid may be delivered to the printhead. Pressure fluctuations or a reduction in the fluid pressure lead to a deterioration of the print image in one or more printheads and thus to inaccuracies or errors when creating a 3D structure.

Furthermore, in known fluid systems, depending on the complexity and number of printheads or dispensing units to be supplied, different fluid pressures can occur in the lines and in the dispensing units of the printheads. Such pressure losses in the lines are primarily caused by different line lengths, bends in the lines with different radii, or line materials with different surface properties or roughness. Such different fluid pressures lead to different volumes of fluid ejected in droplets from the nozzles of the dispensing units, and thus also to inaccuracies or errors in the creation of a 3D structure.

In systems where multiple printheads are supplied from a single tank, a temporarily high fluid demand in the printheads can, for example, lead to a drop in pressure in the supply line. Furthermore, the fill level of the corresponding tank drops relatively quickly. In this case, too, a pressure fluctuation or pressure loss can result in a deterioration of the print image, with corresponding consequences for the quality of the 3D structure being created.

US 2018/0134033A1 discloses a fluid ejection device comprising a circulation channel in which a fluid circulates, a fluid ejection head arranged on the circulation channel for ejecting the fluid, a bypass channel for connecting an upstream portion and a downstream portion of the fluid ejection head, and a switch for switching between a first path in which the bypass channel is part of the circulation channel and a second path in which the bypass channel is not part of the circulation channel, a pressure generator for generating pressure to circulate the fluid in the circulation channel, a degassing device for degassing the fluid in the circulation channel, and a control circuit for performing a degassing process for degassing the fluid by circulating the fluid in the circulation channel.

DE 10 2019 008 328 A1 discloses a metering unit in a printhead of a 3D printer and a method for dosing a fluid in a 3D printer. The object to be achieved is to provide a metering unit in a printhead of a 3D printer and a method for dosing a fluid in a 3D printer, thereby achieving improved quality and reliability in dosing of a fluid using a metering unit.

The solution is a metering unit that has both a supply channel and a discharge channel. This allows the fluid to be kept in motion in the metering unit and flow through the metering unit. This flow also encompasses the fluid outlet area formed at the nozzle. Thus, the fluid is kept in a flowing motion in the metering unit as well as in the fluid outlet area, and changes in the properties of the fluid known from the prior art, such as moisture loss, changes in density, changes in viscosity, changes in the surface tension of the fluid, oxidation phenomena, and others, are prevented, since the fluid is constantly renewed or exchanged.

Thus, a partial solution for preventing flocculates, agglomerations, or blockages is known, at least in the area of a metering unit and thus in the area of a printhead. A solution for fluid stagnating in tanks, intermediate tanks, and especially in lines is not provided.

Thus, there is a need for an improved fluid system and an improved method for supplying a fluid to a printhead in a 3D printer that prevents flocculates or agglomerates of the fluid in the fluid system.

The object of the invention is to provide a fluid system and a method for supplying a fluid to a printhead in a 3D printer, thereby ensuring a reliable supply of the fluid to several metering units in one or more printheads, reducing fluctuations in the fluid pressure and improving a print image during the layer-by-layer generation of a 3D structure.

The problem is solved by a fluid system having the features according to claim 1 of the independent claims. Further developments are specified in the dependent claims.

According to the state of the art, fluid systems for supplying a fluid to a printhead have at least one printhead, which has multiple metering units. This printhead is connected to a printhead tank via a corresponding supply line, and this printhead tank is connected to a storage tank via a fluid line. The fluid for the 3D printer is stored in this storage tank.

Such a storage tank can be located inside or outside the 3D printer. If the storage tank is located outside the 3D printer, it can be positioned next to or above the 3D printer, for example.

According to the invention, each printhead within a printhead unit is connected to the associated printhead tank via a supply line or alternatively via a supply channel and a discharge channel.

The printhead tank and at least one printhead having multiple metering units are arranged in a so-called printhead unit of the inventive fluid system of a 3D printer. The printhead is connected to the printhead tank via a supply line for supplying the fluid, such as a binding agent, extending from the printhead tank to the metering units of the printhead. Alternatively, the printhead is connected to the printhead tank via a supply channel for supplying the fluid, such as a binding agent, from the printhead tank to the metering units of the printhead and a discharge channel for discharging the fluid from the metering units of the printhead back into the printhead tank. In both variants, the fluid is moved from the printhead tank to the printhead by appropriate means, such as pumps.

When multiple printheads are arranged in a printhead unit, several connected printheads and their dispensing units are supplied in parallel from a single printhead tank. The fluid is circulated through each printhead via the supply and discharge channels. For example, six printheads can be arranged in such a printhead unit and connected to the corresponding printhead tank via the supply and discharge channels.

It is provided that a distribution block is arranged in the fluid system between the storage tank and the printhead tank, wherein the distribution block has an inlet which is connected to the storage tank via a fluid feed line, and an outlet which is connected to the storage tank via a fluid return line, wherein the distribution block has at least two further connections, which are each connected via a fluid line to a printhead tank arranged in a printhead unit, and wherein a pump is arranged in the fluid feed line and a control valve is arranged in the fluid return line.

The distribution block according to the invention is connected to a storage tank for supplying the fluid from the storage tank via a fluid feed line. To prevent flocculates or agglomerates, the distribution block is also connected to the storage tank via a fluid return line. The fluid is conveyed from the storage tank via an inlet into the distribution block by means for conveying the fluid, such as a pump arranged in the fluid feed line. In addition, the fluid is conveyed from the distribution block back into the storage tank via an outlet, i.e., the fluid is recirculated or circulated. Continuously circulating the fluid prevents or reduces the formation of flocculates or agglomerates. Due to such continuous movement of the fluid, any flocculates or agglomerates that may have formed can again be dissolved.

The distribution block is provided with an inlet or supply port for introducing the fluid supplied from the storage tank via the fluid feed line into a cavity of the distribution block. Furthermore, the distribution block has a first outlet or drain for discharging the fluid from the cavity of the distribution block into the storage tank via the fluid return line. Furthermore, the distribution block has a number of further connections from the cavity, each connected to a fluid line for supplying an associated printhead tank. The number of further connections provided corresponds to the number of printhead tanks connected or to which fluid is to be supplied. In one example, two to six further connections can be provided.

It is further provided that the fluid supply line and the fluid return line between the storage tank and the distribution block have suitable means allowing control of the fluid circulation without allowing fluid to escape from the system or the lines. In this way, the fluid circulation between the storage tank and the distribution block can be started, its mass flow regulated, or interrupted.

In a first variant, the distribution block may be continuously supplied with fluid from the storage tank when the fluid circulation is activated or permanently started by suitable means. In a second variant, the distribution block may be supplied with fluid from the storage tank only during specific periods. Such suitable means for influencing the fluid circulation include, for example, a pump and/or a control valve.

These specific time periods include, for example, the time between two print processes or print jobs in the 3D printer. During these times, the activated fluid circulation fills the distribution block with fluid from the reservoir so that there is enough fluid in the distribution block to fully complete the subsequent print process.

The distribution block and at least one printhead unit, which comprises a printhead tank and at least one printhead connected to the printhead tank, may also be arranged in a printing unit that can be moved over a construction field of the 3D printer.

The distribution block may have a substantially cuboid-shaped cavity with an at least partially V-shaped cross-section, wherein the outlet of the distribution block is arranged higher than the inlet and spaced apart from the inlet by a height difference.

The distribution block according to the invention is designed such that the outlet, via which the fluid in the cavity of the distribution block is returned to the storage tank via the fluid return line, is arranged in the distribution block above the inlet, via which the fluid is fed from the storage tank into the cavity of the distribution block. Thus, the level of the fluid in the cavity of the distribution block must reach a certain height or height difference above the inlet before fluid is discharged from the distribution block via the outlet. This height difference between the outlet and the inlet is, for example, 10 mm to 80 mm.

It is also intended that an overpressure is generated in the fluid-filled cavity of the distribution block by setting the pressure in the fluid supply line higher than the pressure in the fluid return line. For this purpose, appropriate sensors and pressure generation devices are provided to monitor and adjust these pressure conditions in the lines. This overpressure ensures, on the one hand, that the fluid circulates from the lower inlet to the higher outlet, and, on the other hand, that pressure is equal at the other connections in the lower area, i.e., in the lowest area of the cavity of the distribution block, despite the circulation between the inlet and outlet.

According to the invention, a pump is provided in the fluid feed line and a control valve is provided in the fluid return line as means for generating pressure. For example, a suitable control signal starts the pump and opens the control valve at least partially. This pumps fluid from the storage tank through the fluid feed line to the distribution block. When the fluid level in the distribution block reaches the higher outlet of the distribution block, the fluid flows from the distribution block via the fluid return line and the control valve back to the storage tank in the fluid circulation. If the cross-section of the control valve in the fluid return line is reduced while a constant mass flow of fluid is generated by the pump in the fluid feed line, the pressure acting on the fluid in the area between the pump and the control valve increases, thereby also generating according to the invention an overpressure in the cavity of the distribution block.

Furthermore, the distribution block may have a cavity which, in addition to its essentially cuboidal design, has an at least partially V-shaped cross-section with a downward taper. For example, the cavity can be essentially cuboidal in a first part, while the cavity has an at least partially V-shaped cross-section in a second part, which together with the first part forms the entire cavity.

Moreover, the further connections may be arranged in the narrowest region of the at least partially V-shaped cross-section in the distribution block at a lowest region of the cavity.

The inlet and outlet are arranged at a height difference in the upper area of the distribution block. Several additional outlets are located in the lowest area of the distribution block cavity. In this area, the V-shaped cross-section has its narrowest width. Two or more additional connections are arranged along an imaginary horizontal line along the extent of this lowest area in the longitudinal direction of the distribution block cavity.

By designing the cavity of the distribution block so that the cavity has a height approximately two to five times greater than its width, and is V-shape with a downward taper, uniform pressure conditions are created at all points in the lowest area for the additional outlets connected to the distribution block. Thus, all printhead tanks connected to the additional outlets are evenly supplied with fluid at a comparable pressure, thereby improving the quality of the print image from the printheads.

Example dimensions for the cavity of the distribution block range from 20 mm to 220 mm in length, for example, whereby the length depends on the number of additional connections in the distribution block. The width of the cavity at its widest point is, for example, in a range between 40 mm and 100 mm, while the width of the cavity at its narrowest point can be in a range between approximately 10 mm and 20 mm. The height of the cavity is, for example, in a range between 60 mm and 200 mm. The width of the vertical channels arranged in the lowest area of the cavity as well as the diameters of the holes for the additional connections in the lowest area of the cavity are in a range of approximately 4 mm to 10 mm.

Moreover, the distribution block in the printing unit moving above the construction field may be positioned a short distance away from the printhead tanks of the printhead unit. Furthermore, the fluid lines from the other outlets of the distribution block to the individual printhead tanks are of equal length, if possible. These designs result in comparable fluid pressures in all connected printhead tanks and printheads of all printhead units, thus resulting in a high-quality print image.

The storage tank may also include a means, such as a rotor, for controlled movement of the fluid contained therein. This controlled movement of the fluid in the storage tank prevents formation of flocculates or agglomerates. Such a storage tank may have a capacity of between 10 and 100 liters.

A person skilled in the art will appreciate that such a fluid system for supplying a fluid to a printhead as described herein will also require a number of valves, throttles, sensors, filters and pumps for moving the fluid accordingly and for supplying the fluid to the individual components, although such elements are not fully described here.

The problem is also solved by a method having the features according to claim 6 of the independent patent claims. Further embodiments are recited in the dependent patent claims.

It is provided that in a first step the fluid is conveyed from the storage tank into a distribution block, wherein in order to generate a continuous fluid circulation between the storage tank and the distribution block, the distribution block is connected to the storage tank via a fluid feed line and a fluid return line, that in a second step the fluid is conveyed from the distribution block to a plurality of pressure head tanks via a plurality of further connections provided in the distribution block, and that in the fluid feed line a pump is provided which generates a mass flow of the fluid for the fluid circulation, and that in the fluid return line a control valve is provided which throttles the mass flow of the fluid generated by the pump in the fluid circulation, wherein an overpressure is generated in the region between the pump and the control valve by adjustably throttling the mass flow of the fluid with the control valve, and wherein at the same time an overpressure is also generated in a cavity of the distribution block.

Unlike in the prior art, where the fluid is pumped from a storage tank into a printhead tank of a printhead, wherein the printhead tank is connected to the printhead via a line for supplying the fluid to the printhead, in the present invention, in a first step, the fluid is pumped from the storage tank into a distribution block. This distribution block is connected to the storage tank via both a fluid feed line and a fluid return line, such that the fluid is moved or circulated from the storage tank via the distribution block and back to the storage tank by circulating the fluid. This circulation prevents flocculates or agglomerates both in the distribution block and in the fluid feed line and in the fluid return line of the fluid system.

In a second step, the fluid is conveyed from the distribution block to several printhead tanks via several additional connections provided in the distribution block. In this way, several printhead tanks are supplied from one distribution block, each of which supplies the fluid to at least one printhead with its metering units. Such printhead tanks may, for example, be connected to an associated printhead via a supply line to supply the fluid to this printhead. Alternatively, such printhead tanks may, for example, be connected to two to six printheads to supply the fluid to the respective printhead.

In particular, the invention provides for a pump in the fluid supply line that generates a mass flow of fluid for the fluid circulation, and a control valve in the fluid return line that throttles the mass flow of fluid generated by the pump in the fluid circulation. By adjustable throttling the mass flow of fluid, an overpressure is generated and adjusted in the area between the pump and the control valve, while simultaneously an overpressure is generated in the cavity of the distribution block.

It is also provided that the distribution block is provided with the cavity which has an at least partially V-shaped cross-section, and that the further connections are provided arranged at a lowest region of the cavity, whereby an equal fluid pressure of the fluid supplied to the printhead tanks is generated for all printhead tanks supplied from the distribution block.

The distribution block according to the invention has a substantially cuboid-shaped cavity, which has an at least partially V-shaped cross-section. The distribution block has the V-shaped cross-section preferably in its lower region. In a region located at the lowest point of the distribution block, where the V-shaped cross-section has the smallest width, vertical channels and the additional connections are arranged in a longitudinal extension of the lowest region, which are used to supply the printhead tanks of multiple printhead units via their respective fluid lines. Due to the design of the distribution block with its V-shaped cross-section at least in the lower region, and the arrangement of the additional connections horizontally and in the lowest region of the cavity, an equal fluid pressure is provided at all additional connections to supply the connected printhead tanks. The vertical channels are provided to ensure the supply of fluid to the additional connections, which are located in the lowest region of the cavity of the distribution block, in sufficient quantities in the narrowest region of the V-shaped cross-section of the cavity. One vertical channel is arranged for each additional connection.

Furthermore, within a printhead unit, the fluid from the printhead tank is supplied to the metering units of each printhead via a dedicated fluid feed line and the fluid is returned in a circuit from the metering units of each printhead via a dedicated fluid return line to the printhead tank.

One printhead tank and one printhead connected may be provided to the printhead tank within a so-called printhead unit. Such a printhead unit may also include a printhead tank and several printheads connected to it.

Within such printhead units, the printhead tank is connected to one or more printheads via a fluid supply line for supplying fluid from the printhead tank to the metering units of one or more printheads. Furthermore, the printhead tank is connected to one or more printheads via a fluid return line for returning the fluid from the metering units of one or more printheads to the printhead tank. This creates a circulation from the printhead tank through the metering units of one or more printheads and back to the printhead tank, which can prevent flocculates or agglomerates in the printhead unit, or dissolve them again once they have formed,.

By providing the same fluid pressure to supply the connected printhead tanks and supplying all printheads in the 3D printer's printing unit with the same fluid in a single circulation, a uniform and high-quality print image is achieved when producing the 3D structure in the 3D printer.

It is also planned to provide the printhead units and the distribution block within a printing unit that can be moved over a construction field of the 3D printer.

The distribution block and several printhead units are arranged in a printing unit that can be moved above the construction field of the 3D printer, whereby the printhead units each have a printhead tank and one or more printheads supplied by this printhead tank in a circulation.

In this printing unit, the distribution block is arranged so that the fluid lines leading from the distribution block to the printhead tanks have an equal length to the greatest extent possible in order to ensure equal pressure conditions from the distribution block via the printhead tanks to the printheads and to thus achieve an error-free and precise print image with the printheads of the printing unit.

Furthermore, the distribution block may be arranged so that the fluid lines leading from the distribution block to the printhead tanks can be routed with the smallest possible and most uniform radius. This is also done to ensure consistent pressure conditions in the assemblies.

Moreover, the distribution block in the printing unit may be supplied with fluid from the storage tank continuously or only at specific time intervals, whereby the specific time intervals are times during which no printing process is carried out by the printheads of the 3D printer.

In a first variant, a defined control of the pump and the control valve enables supplying the distribution block with fluid from the storage tank only during specific periods. For example, in the intervals between two print processes or print jobs in the 3D printer, the distribution block is filled with fluid from the storage tank in such a way that the distribution block contains sufficient fluid to fully complete the subsequent print process or print job.

In a second variant, the pressure in the area between the pump and the control valve and thus also in the distribution block may be specifically adjusted by a defined control of the pump and the control valve.

The above-explained features and advantages of this invention will be better understood and appreciated after careful study of the following detailed description of the preferred, non-limiting exemplary embodiments of the invention with the accompanying drawings, which show in:

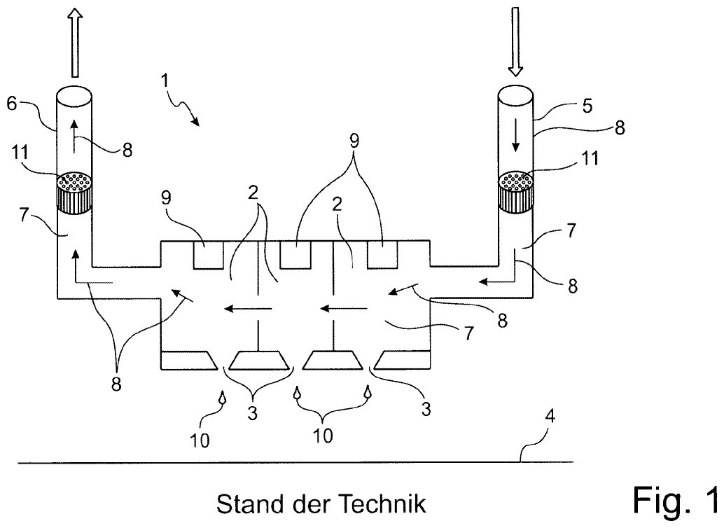

FIG. 1: a printhead with several metering units according to the prior art,

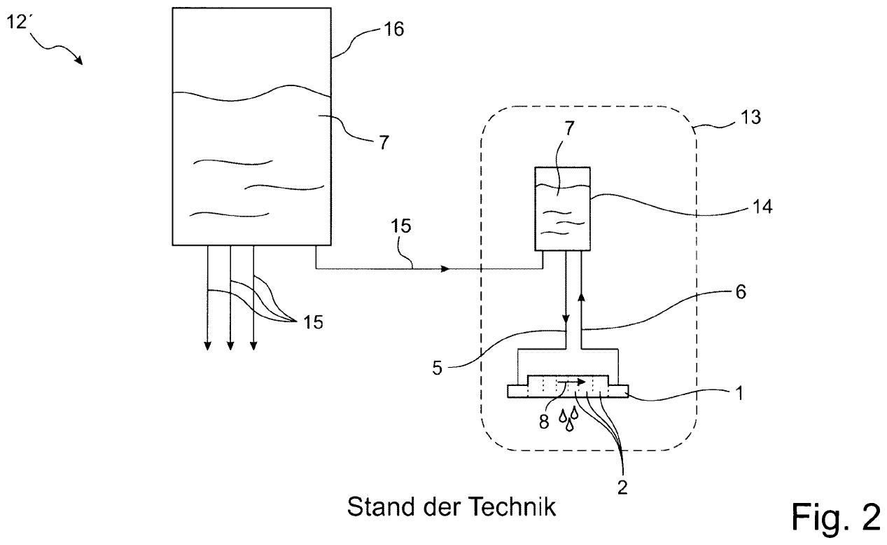

FIG. 2: a fluid system according to the prior art,

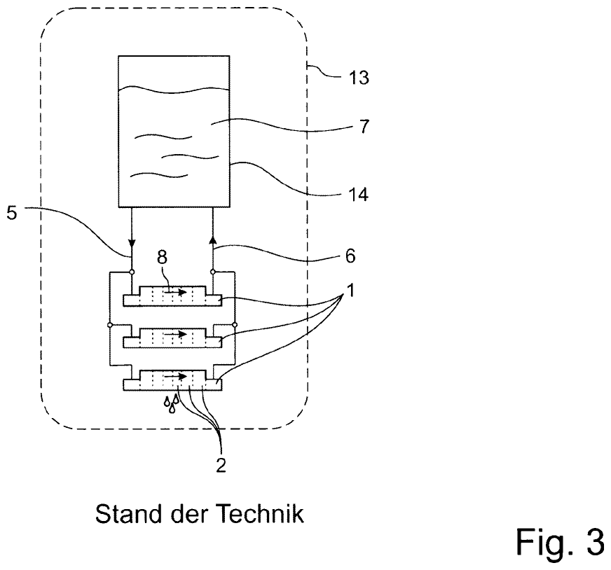

FIG. 3: an arrangement of several printheads in a printhead unit according to the prior art,

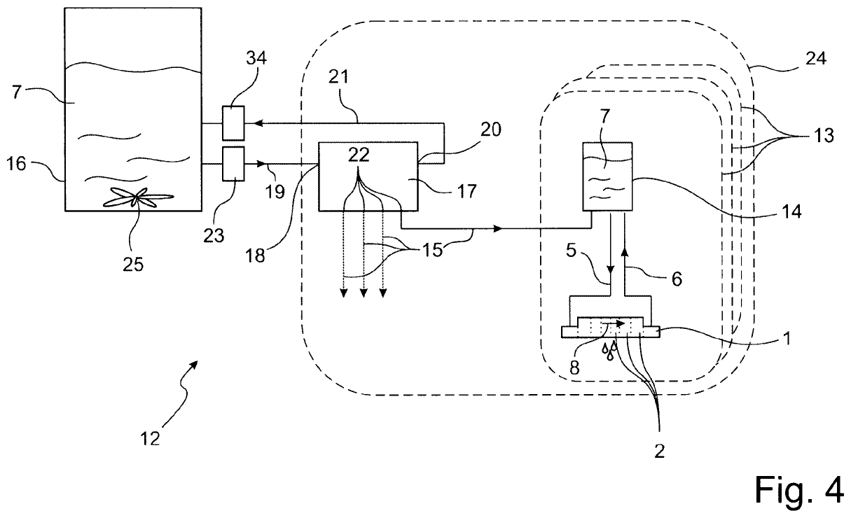

FIG. 4: a fluid system according to the invention, and

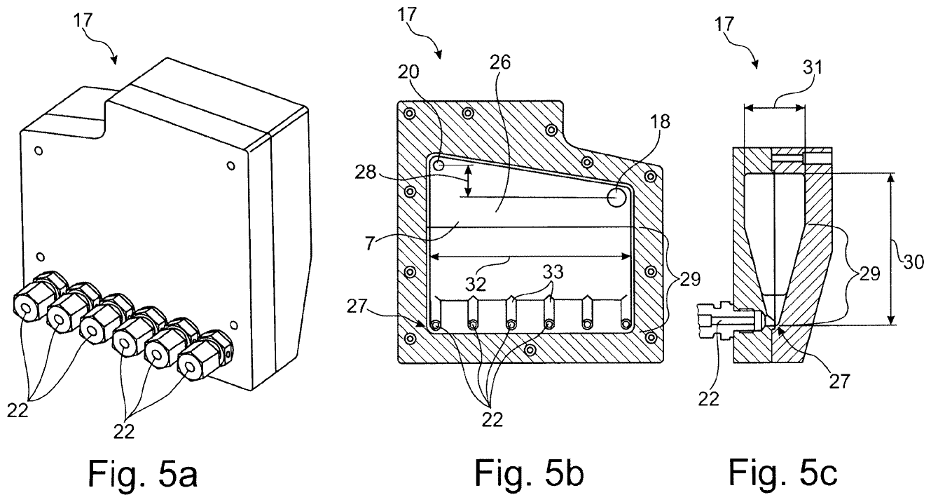

FIGS. 5a, 5b, 5c the distribution block according to the invention in three views.

FIG. 1 shows a printhead 1 with several metering units 2 in a 3D printer according to the prior art in a sectional view using an example with three metering units 2 in a printhead 1. Such metering units 2 may be arranged in a printhead 2, for example, in the form of a matrix having several rows and several columns.

Each metering unit 2 of the printhead 1 has a nozzle 3, which is aligned in one direction of a construction field 4. The metering units 2 are at least partially separated from one another, for example, by corresponding chamber walls, without impairing the supply of the fluid 7. On this construction field 4, a particulate building material (not explicitly shown in FIG. 1) is applied, smoothed, and solidified for the layered construction of a 3D structure. For this purpose, known prior art methods for applying, smoothing, and solidifying the particulate building material are used.

The illustrated printhead 1 has a supply channel 5 and a discharge channel 6. The fluid 7, such as a binding agent, is supplied to the printhead 1 via the supply channel 5 and discharged from the printhead 1 again via the discharge channel 6. The fluid 7 thus flows through the printhead 1 and its metering units 2. This circulation 8 of the fluid 7 through the printhead 1 is represented by several small arrows. Even though FIG. 1 shows an example of a printhead 1 with a circulation 8, it is possible in the present invention to use printheads without a circulation 8, i.e., only with a supply line for supplying the fluid 7, which is not shown in FIG. 1.

The two large arrows above the supply channel 5 and above the discharge channel 6 in FIG. 1 indicate the flow direction of the fluid 7 in the circulation 8. A negative pressure prevents the fluid 7 disposed in the metering units 2 of the printhead 1 from escaping through the nozzle 3.

To meter the fluid 7 via the nozzles 3 of the metering units 2 onto the particulate building material located on the construction site 4, a means 9 for generating a mechanical force is arranged in each metering unit 2. This means 9 for generating a mechanical force generates a mechanical force such as a pressure wave, which propagates from the means 9 itself through the fluid 7 located in the associated metering unit 2 toward the associated nozzle 3, thus ensuring metering of a drop 10 via the corresponding nozzle 3. Such a means 9 may, for example, be a piezo element operating according to the piezoelectric effect.

The drop 10 reaches the surface of the particulate building material located on the construction field 4 and causes a selective solidification of the building material at the point of impact, whereby a partial area of the 3D structure to be created is formed.

The illustrated printhead 1 with its metering units 2 divided into chambers is moved in the usual way over the construction field 4. In this way, the fluid 7 is dosed precisely at the locations necessary for the formation of a 3D structure or a 3D component.

In the example of FIG. 1, a filter element 11 is also provided in the supply channel 5 and a filter element 11 in the discharge channel 6. Alternatively, only one filter element 11 may be provided in the supply channel 5 or one filter element 11 in the discharge channel 6. These filter elements 11 serve to protect against blockages or contamination. This can prevent, for example, clogging of the nozzle 3.

This prior art printhead 1 enables the fluid 7 in the metering units 2 of the printhead 1 to be kept in motion and flow through the printhead 1 in circulation 8. This prevents moisture loss, changes in the viscosity of the fluid 7, oxidation phenomena, and a narrowing of the nozzle 3 due to drying out, thus preventing dosing errors and errors in the print image.

FIG. 2 shows a fluid system 12′ according to the prior art. The fluid system 12′ serves to supply a fluid 7, such as a binding agent, to a printhead 1 in a 3D printer (not shown in FIG. 2). A printhead unit 13 contains a printhead tank 14 and at least one printhead 1 having a plurality of metering units 2. The printhead 1 is connected to the printhead tank 14, for example, via a supply channel 5 for supplying the fluid 7, such as a binding agent, from the printhead tank 14 to the metering units 2 of the printhead 1 and a discharge channel 6 for discharging the fluid 7 from the metering units 2 of the printhead 1 into the printhead tank 14. By corresponding means (not shown), such as pumps, the fluid 7 is moved from the printhead tank 14 to the printhead 1 and back again in a circuit 8.

The printhead tank 14 is connected via a fluid line 15 to a storage tank 16, which serves to store the fluid 7. Thus, the fluid 7 can flow from the storage tank 16 via the fluid line 15 to the printhead tank 14 of the printhead unit 13 shown in FIG. 2. Typically, additional printhead tanks 14 of additional printhead units 13 are connected to such a storage tank 16 via additional fluid lines 15, as indicated in FIG. 2 by three additional fluid lines 15.

FIG. 3 shows an arrangement of several printheads 1 in a printhead unit 13 according to the prior art. In such an arrangement of several printheads 1, each having multiple metering units 2 in a printhead unit 13, all connected printheads 1 with their metering units 2 are supplied in parallel from a printhead tank 14. The fluid 7 is moved through all printheads 1 by means of the supply channel 5 and the discharge channel 6, each in a circulation 8. In the printhead unit 13 shown as an example in FIG. 3, three printheads 1 are arranged and connected to the associated printhead tank 14. A fluid line 15 arranged on the printhead tank 14 for supplying the fluid 7 is not shown in FIG. 3.

FIG. 4 shows a fluid system 12 according to the invention. A printhead tank 14 and at least one printhead 1 having a plurality of metering units 2 are arranged in a printhead unit 13 of the fluid system 12 according to the invention. The printhead 1 is connected to the printhead tank 14 via a supply channel 5 for supplying the fluid 7, such as a binding agent, from the printhead tank 14 to the metering units 2 of the printhead 1 and a discharge channel 6 for discharging the fluid 7 from the metering units 2 of the printhead 1 into the printhead tank 14. By unillustrated means, such as pumps, the fluid is moved from the printhead tank 14 to the printhead 1 and back again in a circulation 8. An arrangement of a plurality of printheads 2 in a printhead unit 13 is also possible, but is not shown in FIG. 4.

According to the invention, a distribution block 17 is arranged between the storage tank 16 and the printhead tank 14. The distribution block 17 has an inlet 18, which is connected to the storage tank 16 via a fluid feed line 19, and an outlet 20, which is connected to the storage tank 16 via a fluid return line 21. The distribution block 17 has at least two further connections 22, which are each connected via a fluid line 15 to a printhead tank 14 in associated printhead units 13. In the example in FIG. 4, the distribution block 17 has four further connections 22. FIG. 4 shows how a further connection 22 is connected to an associated printhead tank 14 via the corresponding fluid line 15. Further connections are shown by a plurality of fluid lines 15 illustrated at the further connections 22 which are only partially shown.

The distribution block 17 is connected to the storage tank 16 for supplying the fluid 7 from the storage tank 16 via the fluid feed line 19. To prevent flocculates or agglomerates, the distribution block 17 is also connected to the storage tank 16 via the fluid return line 21. The fluid 7 is conveyed from the storage tank 16 via an inlet 18 into the distribution block 17 using, for example, a pump 23 arranged in the fluid feed line 19. In addition, the fluid 7 is conveyed back from the distribution block 17 via an outlet 20 into the storage tank 16, i.e., recirculated, for example by using another pump (not shown). Such continuous circulation of the fluid 7 prevents the formation of flocculates or agglomerates, or again dissolves any previously formed flocculates or agglomerates.

According to the invention, a pump 23 generating a mass flow of fluid 7 for the fluid circulation is arranged in the fluid feed line 19, and a control valve 34 throttling the mass flow of fluid 7 generated by the pump 23 in the fluid circulation is arranged in the fluid return line 21. According to the invention, a pressure or overpressure is set in the area between the pump 23 and the control valve 34 by adjustably throttling the mass flow of fluid 7, thereby also generating an overpressure in the cavity 26 of the distribution block 17.

The distribution block 17 and at least one printhead unit 13, which comprises a printhead tank 14 and at least one printhead 1 connected to the printhead tank 14, are arranged in a printing unit 24 that can be moved over a construction field of the 3D printer (not shown). In FIG. 4, three printhead units 13 are arranged in the printing unit 24 by way of example.

It is also provided that the storage tank 16 has a means 25, such as a rotor, for controlled movement of the fluid 7 contained in the storage tank 16. This controlled movement of the fluid 7 in the storage tank 16 prevents the formation of flocculates or agglomerates.

FIGS. 5a, 5b, and 5c show the distribution block 17 according to the invention in three views. FIG. 5a shows the distribution block 17 according to the invention in a perspective view from the outside. FIG. 5b shows the distribution block 17 in a longitudinal section from the inside. FIG. 5c shows the distribution block 17 in a cross-section.

In FIG. 5a, the distribution block 17 is shown, by way of example, with six further connections 22, to which the fluid lines 15 leading to the respective printhead tank 14 are connected. The number of further connections 22 corresponds to the number of connected printhead tanks 14 (not shown) to be supplied with fluid 7 from the distribution block 17. In FIG. 5a, the inlet 18 and the outlet 20 are located on the opposite side of the distribution block 17 and are therefore obscured from view.

The longitudinal section of FIG. 5b shows the essentially cuboid-shaped cavity 26 of the distribution block 17. In the upper right area of the cavity 26, the inlet 18 can be seen, through which the fluid 7 flows from the storage tank 16 and via the fluid feed line 19 into the cavity 26 of the distribution block 17. The storage tank 16 and the fluid feed line 19 are not shown in FIG. 5b.

In the upper left area of the cavity 26, the outlet 20 can be seen, through which the fluid 7 flows from the cavity 26 of the distribution block 17 via the fluid return line 21 to the storage tank 16. The storage tank 16 and the fluid return line 21 are not shown in FIG. 5b.

The distribution block 17 according to the invention is designed such that the outlet 20 is arranged above the inlet 18 in the cavity 26. Thus, the level of the fluid 7 located in the cavity 26 of the distribution block 17 must reach a height or height difference 28 above the inlet 18 before fluid 7 is discharged from the cavity 26 of the distribution block 17 via the outlet 20. This height difference 28 between the outlet 20 and the inlet 18 is, for example, 10 mm to 80 mm.

Furthermore, the distribution block 17 has a cavity 26 with an at least partially V-shaped cross-section 29 that tapers downwards. In the example, the cavity 26 is essentially cuboid-shaped in the upper part and at least partially formed with a V-shaped cross-section 29 in the lower part.

In the lower region of the cavity 26 of the distribution block 17 there is at least one lowest region 27. In this region 27 the V-shaped cross section 29 has the smallest width.

In an extension of this lowest region 27 in a longitudinal direction of the distribution block 17 or the cavity 26, two or more further connections 22 are arranged along an imaginary horizontal line. The example in FIG. 5b shows six such horizontally arranged further connections 22.

By designing the cavity 26 of the distribution block 17 such that the cavity 26 has a height 30 that is approximately two to five times greater than the width 31 of the cavity 26, and a V-shape 29 with a downward taper, uniform pressure conditions in the form of a uniform overpressure are created at all points in the lowest region 26 for the further connections 22 connected to the distribution block 17. Thus, all printhead tanks 14 connected to the further connections 22 (not shown in FIGS. 5a, 5b, 5c) are evenly supplied with fluid 7 at a comparable pressure, thereby improving the quality of the print image of the printheads 1 (also not shown). The cavity 26 of the distribution block 17 also has a length 32, which is shown in FIG. 5b. In the design of the cavity in FIG. 5b, short vertical channels 33 are provided in the lowest region of the V-shaped cross-section 29, where its width is smallest, in order to ensure the supply of the fluid 7 to the other connections in sufficient quantity.

According to the method, the fluid 7 is conveyed from the storage tank 16 into the distribution block 17 in a first step, wherein, in order to generate a continuous fluid circulation between the storage tank 16 and the distribution block 17, the distribution block 17 is connected to the storage tank 16 via the fluid feed line 19 and the fluid return line 21. In a second step, the fluid 7 pressurized in the distribution block 17 is conveyed from the distribution block 17 via a plurality of further connections 22 provided in the lowest region 27 of the distribution block 17 via respective fluid lines 15 to a plurality of printhead tanks 14.

Since the distribution block 17 is connected to the storage tank 16 via both a fluid feed line 19 and a fluid return line 21, via which the fluid 7 is moved or circulated in a fluid circuit starting from the storage tank 16 via the distribution block 17 and back to the storage tank 16, flocculates or agglomerates are prevented both in the distribution block and in lines 19 and 21 of the fluid system 12.

It is intended that an overpressure is generated in the cavity 26 of the distribution block 17 filled with fluid 7 by setting the pressure in the fluid feed line 19 higher than the pressure in the fluid return line 21. For this purpose, corresponding sensors and means for pressure generation are provided to allow monitoring and adjusting these pressure conditions of the fluid 7 in the lines.

It is intended that the fluid 7 is conveyed from the distribution block 17 to several printhead tanks 14 in the second step with the same fluid pressure in all connected fluid lines 15 extending to the printhead tanks 14.

The fluid feed line 19 and the fluid return line 21 between the storage tank 16 and the distribution block 17 may have an interface 23, by which the fluid circulation between the storage tank 16 and the distribution block 17 can be temporarily interrupted without allowing fluid 7 to escape from the system or the lines 19 and 21.

Thus, the distribution block 17 can be permanently supplied with fluid 7 from the storage tank 16 when the interface 23 is closed or only during certain time periods when the interface 23 is not open.

The specific time periods are, for example, times between two print processes or print jobs in the 3D printer. During these times, the distribution block 17 is filled with fluid from the storage tank 16 via the closed interface 23 such that sufficient fluid 7 is contained in the distribution block 17 to fully carry out the subsequent print process while the interface 23 is open.

### LIST OF REFERENCE SYMBOLS

1 printhead
2 metering unit
3 nozzle
4 construction site
5 supply channel
6 discharge channel
7 fluid
8 circulation
9 means of generating a force
10 drops
11 filter element
12, 12′ fluid system
13 printhead unit
14 printhead tank
15 fluid line
16 storage tank
17 distribution block
18 inlet
19 fluid feed line
20 outlet
21 fluid return line
22 further connections
23 pump
24 pressure unit
25 means of controlled movement
26 cavity
27 lowest area
28 difference in height
29 V-shaped cross-section
30 height
31 width
32 length
33 channel
34 control valve

1. A fluid system (12) for supplying a fluid (7) to a printhead (1) in a 3D printer, wherein the printhead (1) has a plurality of metering units (2) and is connected to a printhead tank (14), and wherein the printhead tank (14) is connected at least indirectly via a fluid line (15) to a storage tank (16) for storing the fluid (7), wherein a distribution block (17) is arranged between the storage tank (16) and the printhead tank (14), wherein the distribution block (17) has an inlet (18) connected to the storage tank (16) via a fluid feed line (19), and an outlet (20) connected to the storage tank (16) via a fluid return line (21), wherein the distribution block (17) has at least two further connections (22), each of which is connected to a respective printhead tank (14) via a fluid line (15). and wherein a pump (23) is arranged in the fluid feed line (19) and a control valve (34) is arranged in the fluid return line (21).

2. The fluid system (12) according to claim 1, wherein the distribution block (17) and at least one printhead unit (13), which comprises a printhead tank (14) and at least one printhead (1) connected to the printhead tank (14), are arranged in a printing unit (24) that can be moved over a construction field of the 3D printer.

3. The fluid system (12) according to claim 1, wherein the distribution block (17) has a cavity (26) designed with an at least partially V-shaped cross-section (29), and where in the distribution block (17) the outlet (20) is spaced apart from the inlet (18) by a height difference (28) and is arranged higher than the inlet (18).

4. The fluid system (12) according to claim 3, wherein the further connections (22) are arranged in the narrowest region of the at least partially V-shaped cross-section (29) in the distribution block (17) at a lowest region (27) of the cavity (26).

5. The fluid system according to claim 1, wherein in a the printhead unit (13) each printhead (1) is arranged connected to the associated printhead tank (14) via a supply channel (5) and a discharge channel (6).

6. A method for supplying a fluid (7) to a printhead (1) in a 3D printer, wherein a the fluid (7) is conveyed from a storage tank (16) at least indirectly into at least one printhead tank (14) of the printhead (1), wherein the printhead tank (14) is connected to a printhead (1) for supplying the fluid (7) to the printhead (1), conveying the fluid (7) in a first step from the storage tank (16) into a distribution block (17), wherein for generating a continuous fluid circulation between the storage tank (16) and the distribution block (17), the distribution block (17) is connected to the storage tank (16) via a fluid feed line (19) and a fluid return line (21), and in a second step the fluid (7) is conveyed from the distribution block (17) via a plurality of further connections (22) provided in the distribution block (17) to a plurality of printhead tanks (14) and a pump (23) generating a mass flow of the fluid (7) for the fluid circulation is provided in the fluid feed line (19) and a control valve (34) throttling the mass flow of the fluid (7) generated by the pump (23) in the fluid circulation is provided in the fluid return line (21), wherein an overpressure is generated in the area between the pump (23) and the control valve (34) by adjustably throttling with the control valve (34) the mass flow of the fluid (7), wherein at the same time an overpressure is also generated in a cavity (26) of the distribution block (17).

7. The method according to claim 6, providing the distribution block (17) with the cavity (26) which has an at least partially V-shaped cross-section and, the further connections (22) are arranged at a lowest region (27) of the cavity (26), whereby an identical fluid pressure of the fluid (7) supplied to the printhead tanks (14) is generated for all printhead tanks (14) supplied from the distribution block (17) via associated fluid lines (15).

8. The method according to claim 6, wherein the fluid (7) from the printhead tank (14) is supplied to the metering units (2) of each printhead (1) within a printhead unit (13) via a respective supply channel (5) and that the fluid (7) is returned in a circulation from the metering units (2) of each printhead (1) via a respective discharge channel (6) to the printhead tank (14).

9. The method according to claim 6, wherein the printhead unit (13) and the distribution block (17) are provided within a printing unit (24) which can be moved over a construction field of the 3D printer.

10. The method according to claim 6, wherein the continuous fluid circulation between the storage tank (16) and the distribution block (17) is generated by means of a pump (23) provided in the fluid feed line (19) or the fluid return line (21).
